(19) United States
(12) Patent Application Publication
(10) Pub. No.: US 2023/0254500 A1
(43) Pub. Date: Aug. 10, 2023

(54) SMART PACKET PACING FOR VIDEO FRAME STREAMING

(71) Applicant: NVIDIA Corporation, Santa Clara, CA (US)

(72) Inventors: Hassane Samir Azar, Los Altos, CA (US); Keshava Prasad, Bangalore (IN)

(21) Appl. No.: 17/666,331

(22) Filed: Feb. 7, 2022

(51) Int. Cl. H04N 19/51; H04N 19/176; H04N 19/91; H04N 19/65

(52) U.S. Cl. CPC H04N 19/51; H04N 19/176; H04N 19/91; H04N 19/65

(57) ABSTRACT

In various examples, a frame may be encoded as multiple sub-frames. For example, data particularly relevant to conveying visual motion between frames may be encoded in a first sub-frame(s) with remaining data being encoded in a second sub-frame(s). Other information may be included in the first sub-frame(s), such as high entropy data. The high entropy data may be estimated using quantization and dequantization of macroblocks. Packet pacing may be applied at least between the encoded sub-frames. As the first sub-frame(s) may include the most important information for frame updates at the client device, if the second sub-frame(s) is not received and/or displayed the first sub-frame may be displayed providing high quality results. More error correction may be used for the first sub-frame than the second sub-frame to increase the likelihood that the first sub-frame is received at a client device.

### BACKGROUND

Traditional video streaming relies on encoding and packetizing frames of video. Generally, frames may be divided into a set of macroblocks and may be encoded as a particular type of frame, such as an intra-frame (I-frame), a predicted frame (P-frame), or a bi-directional frame (B-frame). An I-frame may include macroblock data encoded relative to other macroblocks within the same I-frame. A P-frame may include macroblock data encoded relative to other macroblocks within the same P-frame, but may also include macroblock data encoded relative to a previous frame (e.g., temporally prior to the frame being generated). A B-frame may include macroblock data encoded relative to a previously generated frame or a frame that occurs later.

A traditional approach to transmitting packets of an encoded frame uses a single burst of data packets to communicate the information to a client device (e.g., the device intended to display the frame). Due to the size of the burst, not all packets may be received by the client—resulting in visual artifacts like stutter and corruption when displaying the video stream. Packet pacing may be used to improve the resiliency of frame transmission. Conventional approaches to packet pacing send the packets for an encoded frame using a series of smaller data packet bursts separated by a predetermined delay to communicate the information to the client device. Using smaller bursts of packets with delays may improve the probability that the packets reach the client device. However, packet loss can occur even when using packet pacing and the delays increase latency, which may result in visually disruptive artifacts being presented on the client device (e.g., stutter). For example, conventional packet pacing may be used to reduce corruption (e.g., resulting in tearing) due to packet loss, but frame delay may occur due to increased latency.

### SUMMARY

The present disclosure relates to systems and methods for encoding and transmitting video frames for streaming. More specifically, the current disclosure relates to selective encoding of data for a frame into one or more sub-frames (also referred to as “encoding layers” or generally “layers”), and the prioritized transmission of the sub-frame(s) in a packetized manner. Some implementations are facilitated using entropy-based masks that identify macroblocks of frame data that may require a relatively high amount of bits to encode.

In contrast to traditional approaches, such as those described above, disclosed approaches may encode a frame as multiple sub-frames. For example, data particularly relevant to conveying visual motion between frames may be encoded in a first sub-frame(s) with remaining data being encoded in a second sub-frame(s). In addition to or instead of motion information, other information may be included in the first sub-frame(s), such as high entropy data, which may correspond to edges, occlusions and disocclusions, and other sudden or large changes between frames. Disclosed approaches provide techniques for estimating the high entropy data. Packet pacing may be applied at least between the encoded sub-frames (e.g., and in some embodiments within sub-frames). As the first sub-frame(s) may include the most important information for frame updates at the client device, if the second sub-frame(s) is not received and/or displayed the first sub-frame may be displayed providing high quality results. In one or more embodiments, more error correction may be used for the first sub-frame than the second sub-frame to increase the likelihood that the first sub-frame is received at a client device.

Some of the embodiments of the systems and methods described herein may facilitate streaming with lower delay, higher resilience to stutter, and higher resilience to corruption than traditional approaches to streaming, such as those described above. For example, a sub-frame including the data particularly relevant to conveying visual motion between frames may be communicated to a client device prior to, or during, generation of the frame including the remaining data. In some embodiments, the prioritized transmission of the sub-frames may allow for a greater probability of delivery of the data particularly relevant to convey visual motion to the client device when a network delay event occurs. Similarly, where an event occurs that corrupts the frame data, some embodiments of the systems and methods described herein may allow for recovery and display of the data particularly relevant to conveying visual motion.

### BRIEF DESCRIPTION OF THE DRAWINGS

The present systems and methods for smart packet pacing using sub-frames for video frame streaming are described in detail below with reference to the attached drawing figures, wherein:

FIG. 1 is a block diagram of an example process for generating multiple sub-frames, in accordance with some embodiments of the present disclosure;

FIG. 2 includes diagrams of an example current frame and an example frame mask, in accordance with some embodiments of the present disclosure;

FIG. 3 is a diagram of an example process for estimating bit cost based on an estimate of entropy, in accordance with some embodiments of the present disclosure;

FIG. 4 is a block diagram of an example method for encoding one or more sub-frames, in accordance with some embodiments of the present disclosure;

FIG. 5A is a block diagram of an example process for display of frames based on one or more sub-frames, in accordance with some embodiments of the present disclosure;

FIG. 5B is block diagram of another example process for display of frames based one or more sub-frames, in accordance with some embodiments of the present disclosure;

FIG. 6 is a block diagram of an example method for decoding and displaying a frame based on one or more sub-frames, in accordance with some embodiments of the present disclosure;

FIG. 7 is a block diagram of an example content streaming system suitable for use in implementing some embodiments of the present disclosure;

FIG. 8 is a block diagram of an example data center suitable for use in implementing some embodiments of the present disclosure; and

FIG. 9 is a block diagram of an example computing device suitable for use in implementing some embodiments of the present disclosure.

### DETAILED DESCRIPTION

The present disclosure relates to systems and methods for encoding and transmitting video frames for streaming. More specifically, the current disclosure relates to selective encoding of data for a frame into at least two sub-frames and the prioritized transmission of the sub-frames in a packetized manner. Some implementations are facilitated using entropy-based masks that identify macroblocks of frame data that may require a relatively high amount of bits to encode.

Disclosed approaches may encode a frame as multiple sub-frames (e.g., a base sub-frame and an enhancement sub-frame) to increase the probability that important data for a frame is received over a network for display. For example, each sub-frame (e.g., each being P-frame) may encode at least some different frame data. As such, data particularly relevant to conveying visual motion between frames may be encoded in a first sub-frame(s) (e.g., a base sub-frame) with remaining data being encoded in a second sub-frame(s) (e.g., an enhancement sub-frame). In addition to or instead of motion information, other information may be included in the first sub-frame(s), such as high entropy data, which may correspond to edges, and other details (e.g., by applying a mask to the residual of a motion-compensated frame). Further disclosed approaches provide techniques for estimating the high entropy data. Packet pacing may be applied at least between the encoded sub-frames (e.g., and in some embodiments within sub-frames). As the first sub-frame(s) may include the most important information for frame updates at the client device, if the second sub-frame(s) is not received and/or displayed the first sub-frame may be displayed providing high quality results. In one or more embodiments, more error correction may be used for the first sub-frame than the second sub-frame to increase the likelihood that the first sub-frame is received at a client device.

In some embodiments, the first sub-frame may be a P-frame that includes encoded macroblock data that, when rendered by a client device, transitions a portion of the previously rendered and/or decoded frame to a current frame (e.g., the frame, directly or indirectly, displayed by the client device). While P-frames are primarily described, the first sub-frame may be a different type of frame, such as a B-frame.

An encoder may generate an encoded version of the first sub-frame. In some embodiments, the encoded version of the first sub-frame may be an encoded P-frame capturing differences between the previous frame (e.g., displayed on a client device) and the first sub-frame.

A second sub-frame(s) (e.g., an enhancement or residual sub-frame) may be encoded with data relevant to rendering the remaining (e.g., the residual) visual information of the frame. For example, macroblocks that are not associated with movement and/or macroblocks with a bit cost (e.g., an estimate of how much data is needed to encode a macroblock) less than or equal to a threshold may be included in the second sub-frame. An encoder may generate an encoded version of the second sub-frame. In some embodiments, the encoded version of the second sub-frame may be an encoded P-frame capturing differences between the base frame and the current frame (e.g., to be displayed of the client device).

In at least one embodiment, the first sub-frame(s) may be generated based on a motion-compensated frame, which may be computed from the estimated motion between the preceding frame (e.g., using motion vectors). For example, the movement of visual elements within the previous frame may be estimated and macroblocks corresponding to the portion(s) of the frame associated with movement may be identified. Additionally, in some embodiments, the bit cost may be computed for each macroblock (and/or groups of macroblocks) in the frame. A bit cost may correspond to an estimate of entropy for the macroblock(s). Macroblocks with a bit cost greater than a threshold value may be included in the first sub-frame. The bit cost threshold value may be determined in a number of ways. For example, the threshold value may be based at least on the mean (or other statistical value) bit cost of macroblocks within the frame. Additionally, the threshold value may be based at least on a number of standard deviations (e.g., 1, 2, or 3) from the mean (or other statistical value) bit cost of macroblocks within the frame.

In one or more embodiments, the transmission of the first sub-frame(s) from the encoding system to the rendering client device may be prioritized such that packets representing the first encoded sub-frame are transmitted prior to packets representing the second encoded sub-frame. For example, in an embodiment, at least some of the encoded version of the first sub-frame may be transmitted while at least some of the encoded version of the second sub-frame is being generated. The encoded first sub-frame and/or second sub-frame may be packetized for transmission, in some embodiments. For example, the first sub-frame may be packetized to facilitate rapid transmission of the first sub-frame through high load networks. Further, the transmission of each packet and/or sub-frame may be paced with a predetermined interval between each packet and/or sub-frame. In at least one embodiment, packet pacing may be applied within the second encoded sub-frame and not within the first encoded sub-frame, or may be used for both sub-frames or sub-frame types. To further enhance the resiliency of transmitting the sub-frames (e.g., the first sub-frame and/or the second sub-frame), one or more of the sub-frames may be transmitted using error correction, such as forward error correction (FEC). As the first encoded sub-frame(s) may include data more critical to display on the client device, more error correction may be used for the first sub-frame than the second sub-frame (which may not include error correction in some embodiments).

The use of the systems and processes described herein may facilitate streaming video in a manner that is resilient to the effects of frame corruption and frame delay. One or more embodiments may be especially beneficial for latency sensitive and/or high bandwidth video streaming applications, such as streaming video for interactive content such as game streaming.

During a streaming/cloud gaming session, a large number of frames may be encoded and transmitted to a client device. In one or more embodiments one or more of the sub-frames may be pre-encoded prior to streaming. The encoded sub-frames or series of encoded sub-frames may be decoded and rendered or displayed by the client device. During the inter-frame period (e.g., the interval of time between display of the current frame and display of the next frame), the host server(s) may determine contents of the next frame and/or sub-frames, encode the sub-frames of the frame, and transmit the encoded sub-frames to the client device.

Also during the inter-frame period, the client device may decode one or more of the sub-frames (which may depend on whether each has been received) and render and/or display a next frame. A delay or failure to receive any packet of an encoded frame may conventionally cause the render to fail (e.g., frame drop) or create substantial visual artifacts (e.g., tearing) in the next frame. However, by encoding and transmitting video using sub-frames, network delays and/or dropped packets can be more reliably addressed. For example, in a situation where data corresponding to a residual derived sub-frame is received late or corrupted, the client device may determine (e.g., after a threshold time) to present a frame generated from the predicted motion derived sub-frame with minimal visual impact (e.g., by applying the P-frame to the previously displayed frame). Additionally or alternatively, the client device may determine to present the frame to reduce decoding costs even where all sub-frames are received. Additionally or alternatively, in a situation where the server may determine to not send a residual derived sub-frame (e.g., due to bandwidth and/or network constraints and to improve network performance) the frame may be presented.

Disclosed approaches may be implemented on a system comprised in at least one of a control system for an autonomous or semi-autonomous machine, a perception system for an autonomous or semi-autonomous machine, a system for performing simulation operations, a system for performing deep learning operations, a system implemented using an edge device, a system implemented using a robot, a system incorporating one or more virtual machines (VMs), a system implemented at least partially in a data center, a system including a collaborative creation platform for three-dimensional (3D) content, or a system implemented at least partially using cloud computing resources.

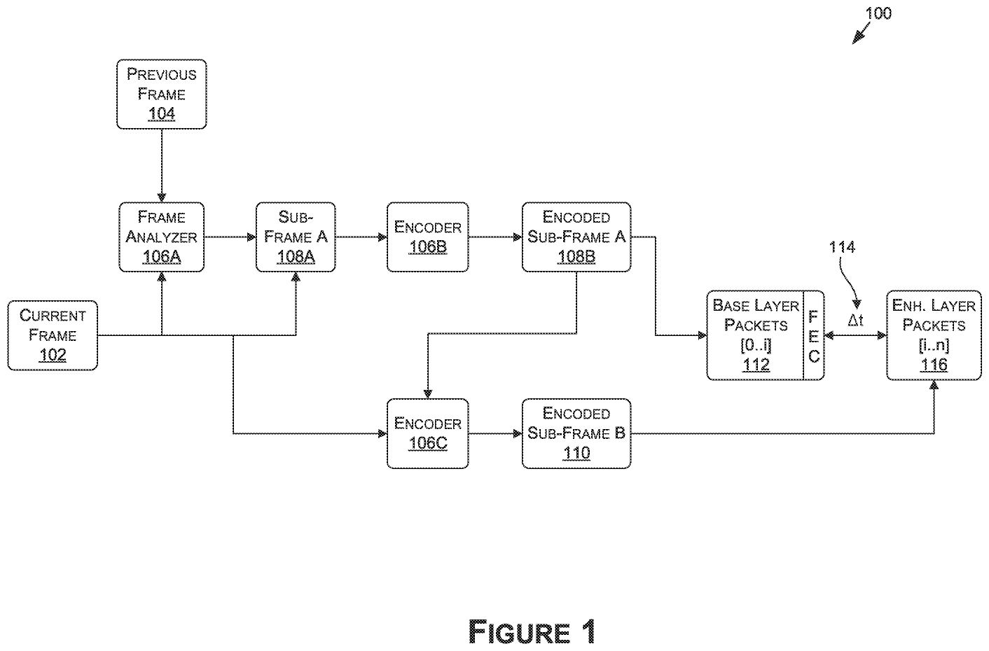

With reference to FIG. 1, FIG. 1 is an example process 100 for generating multiple sub-frames, in accordance with some embodiments of the present disclosure. It should be understood that this and other arrangements described herein are set forth only as examples. Other arrangements and elements (e.g., machines, interfaces, functions, orders, groupings of functions, etc.) may be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by entities may be carried out by hardware, firmware, and/or software. For instance, various functions may be carried out by a processor executing instructions stored in memory.

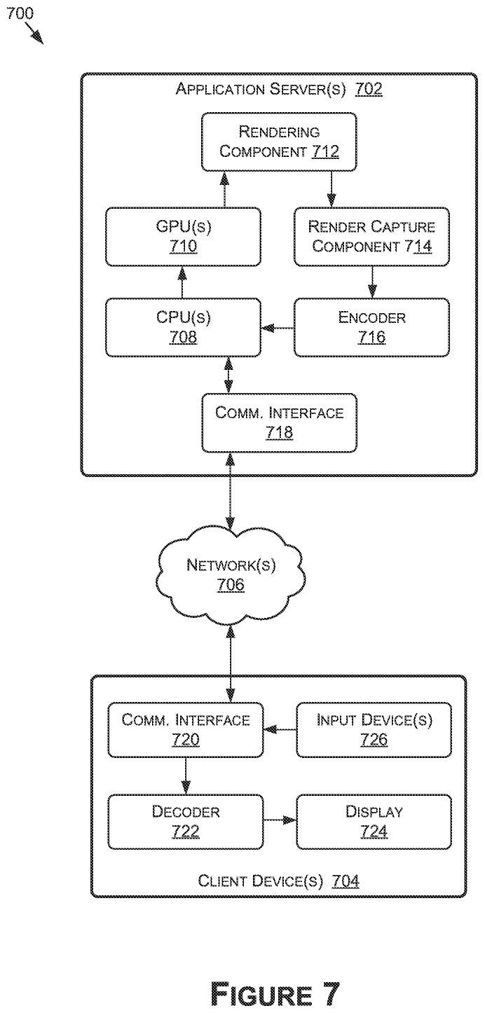

At a high level, the process 100 may include encoding one or more sub-frames (e.g., the sub-frame 108A of a current frame 102) that facilitate the transition between individual frames in a series of frames. The encoded sub-frames may be communicated by one or more server(s) (e.g., application server 702 of FIG. 7), via a network, to a client device for decoding and display. When displayed by the client device (e.g., client device(s) 704 of FIG. 7) the series of frames may facilitate the perception of movement of visual elements in the frames over time.

The process 100 may be performed using, for example, a frame analyzer 105 and one or more encoder(s) (e.g., an encoder 106A and an encoder 106B, which may be the same or different encoders). Some embodiments of the process 100 may be implemented by an application server (e.g., an application server 702 of FIG. 7) that hosts or supports a streaming video service (e.g., a game streaming service). For example, various functions describe in relation to the frame analyzer 105, the encoder 106A, and/or the encoder 106B may be a implemented, at least in part, using a CPU(s) 708, a GPU(s) 710, a rendering component 712, a rendering capture component 714, an encoder 716, and/or any combination thereof, each of which is described further in relation to FIG. 7.

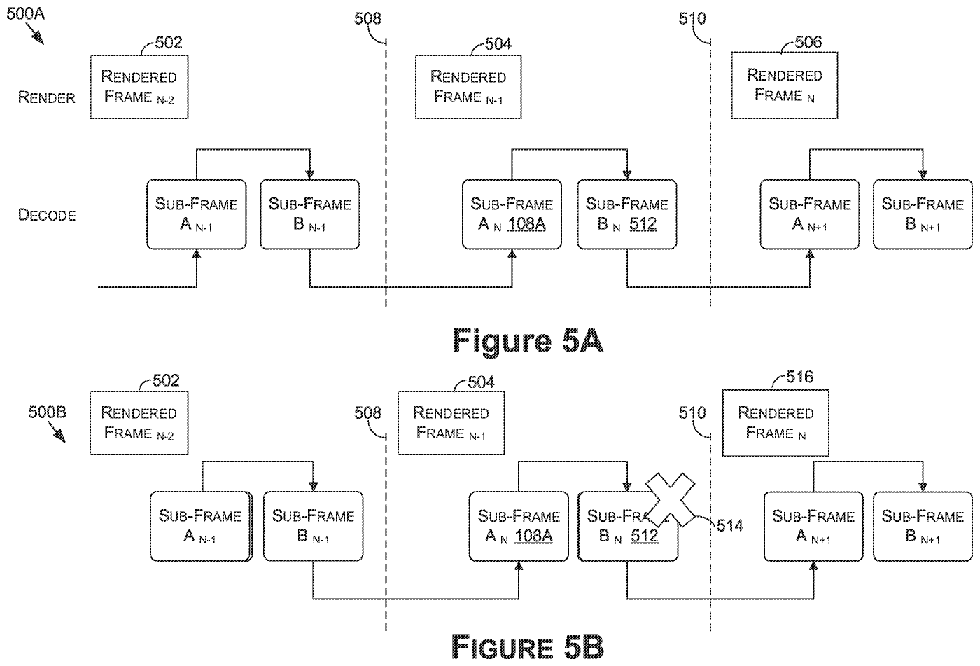

Some embodiments of the process 100 may include the frame analyzer 105 receiving the current frame 102 and a previous (or previously reconstructed “reference”) frame(s) 104 (e.g., a preceding frame in the video and/or stream) as input. The current frame 102 may be represented using a set of pixel data for a frame that is to be displayed by a remote client device (e.g., a client device 704 of FIG. 7) at a point in time after display of a frame corresponding to the previous frame(s) 104. For example, the current frame 102 may be encoded, transmitted for display using a client device, and decoded to render the frame for display using the client device (e.g., a frame_{N} 506 of FIG. 5A). The previous frame(s) 104 may be prior to the current frame(s) 102 in a temporal sequence of frames and is encoded, transmitted for display using the client device, and decoded to render the frame for display using the client device (e.g., a frame_{N-1} 504 of FIG. 5A).

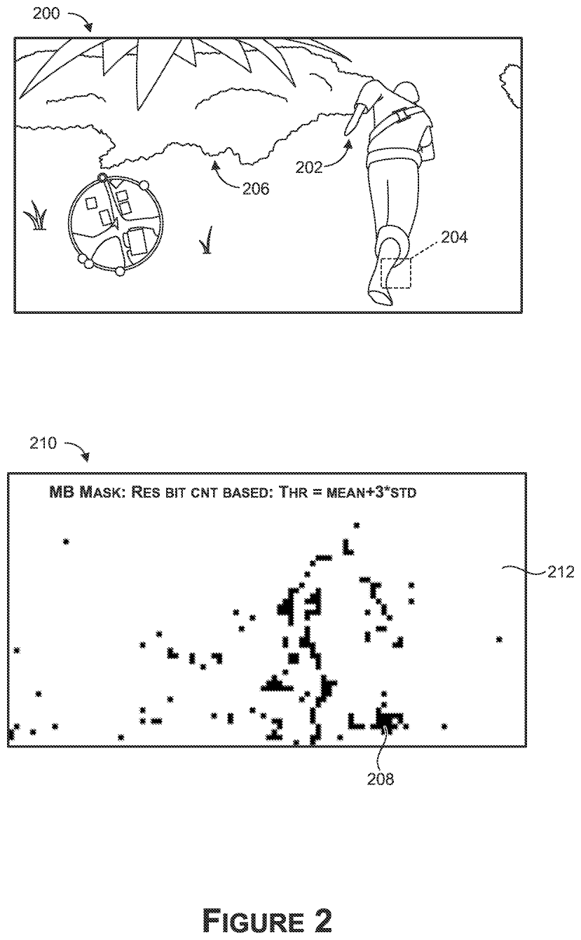

Generally, the frame analyzer 105 may be configured to analyze visual content of one or more frames in order to determine one or more sub-frames. For example, the frame analyzer 150 may be configured to analyze the current frame 102 and the previous frame 104 to determine the sub-frame 108A. In one or more embodiments, the frame analyzer 105 may distinguish between macroblocks of a frame(s) that convey motion from macroblocks of the frame(s) that may be non-essential to convey the motion. As a non-limiting example, macroblocks that convey motion between frames (e.g., the current frame 102 and the previous frame 104) may correspond to changes in the locations of objects and/or changes in camera position between frames. For example, and with brief reference to FIG. 2, a frame 200 (e.g., corresponding to the current frame 102) may depict a character 202. One or more frames preceding the frame 200 may depict the same character 202 with the character's limbs positioned slightly differently (e.g., based on a run cycle). Macroblocks capturing changes in the location of the character 202 in at least the region 204 may convey motion of character 202 through the series of frames. In contrast, macroblocks corresponding to the object 206 may not be essential to convey motion.

Additionally or alternatively, to facilitate output of the sub-frame 108A, the frame analyzer 105 may include one or more algorithms that estimate entropy of residuals for the macroblock(s) of the current frame 102. In one or more embodiments, the entropy for a macroblock may correspond to a bit cost to encode the residual of the macroblock. In one or more embodiments, the frame analyzer 105 may include algorithms that estimate the entropy of the macroblock(s) using the bit cost to encode the macroblock rather than the residual of the macroblock. Thus, the sub-frame 108A may identify macroblocks (either using the macroblocks or their corresponding residuals) that correspond to a high bit cost for inclusion in the sub-frame 108A. Such macroblocks may correspond to, for example, edges of objects and/or changes in color or luminance of the current frame 102. For example, edges of the character 202 may correspond to high entropy macroblocks.

To account for motion between frames when generating the sub-frame 108A, the frame analyzer 105 may implement one or more algorithms that estimate motion between two or more frames. For example, the frame analyzer 105 may use a motion estimation function to compute an estimate of motion between the current frame 102 and the previous frame 104. The motion estimation function may be any suitable function. Non-limiting examples include those based on block matching, phase correlation and frequency domain methods, pixel recursive algorithms, and/or optical flow. Additionally, using the motion estimation, the frame analyzer 105 may compute a motion-compensated frame that predicts the current frame 102, given the previous frame(s) 104 (and/or future frames in some embodiments).

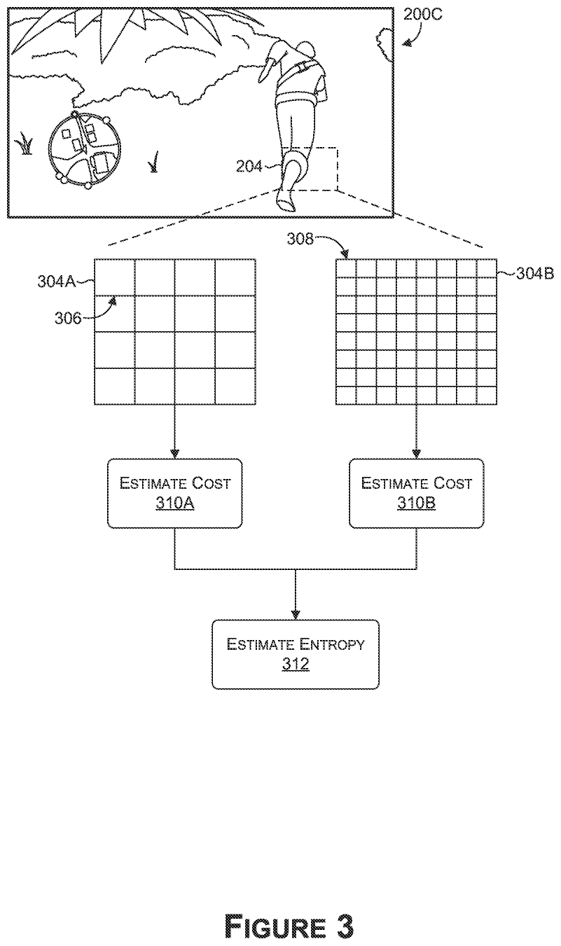

In one or more embodiments, the sub-frame 108 may be comprise at least some of the frame data corresponding to the motion-compensated frame. For example, the sub-frame 108A may be the motion-compensated frame or at least some of the data from the motion-compensated frame may be included in the sub-frame 108A. By way of example and not limitation, at least some frame data may be added to the motion-compensated frame to produce the sub-frame 108A. For example, the frame analyzer 105 may compute a residual of the motion-compensated frame and the current frame 102. The residual may be computed using an algorithmic function that subtracts the motion-compensated frame from the current frame 102 to produce the residual frame (e.g., a residual frame 200C of FIG. 3). The frame analyzer 105 may then analyze the residual to determine whether to include frame data for one or more macroblocks that may not otherwise be included in the sub-frame 108A according to the motion-compensated frame alone. For example, the frame analyzer 105 may analyze the residual to identify high entropy data (e.g., above a threshold value) to include in the sub-frame 108A, as described herein.

To identify data to include in the sub-frame 108A based on corresponding entropy, the frame analyzer 105 may compute a bit cost associated with the data. As described herein, a bit cost may correspond to an estimate of how much data is needed to encode a macroblock (and/or groups of macroblocks). In some embodiments, a bit cost may be computed for each macroblock (and/or groups of macroblocks) in a residual frame.

In some embodiments, the frame analyzer 105 may apply one or more macroblock filters, such as logical rules, thresholds, or masking algorithms that facilitate, at least in part, identifying macroblocks that are included in the sub-frame 108A. For example, a filter of may identify macroblocks of a residual frame (e.g., the residual frame 200C of FIG. 3) based at least on comparing corresponding bit costs to a bit cost threshold. The bit cost threshold value may be a predetermined value or vary based on the frame being evaluated. For example, the threshold value may be or be based at least on the mean, median, or other statistically derived bit cost value for macroblocks within the residual frame. In an embodiment, the bit cost threshold value may be determined based on an estimate of entropy for the macroblocks of the residual frame. The bit cost threshold for a filter may be the mean estimate of entropy, or a number of standard deviations (e.g., 1, 2, or 3) from the mean estimate of entropy.

A bit cost for a macroblock(s) may be computed using a variety of possible approaches. In one or more embodiments, the bit cost may be computed based at least on quantizing a discrete cosine transform (DCT) of the macroblock(s), then dequantizing the quantized data. Various quantization parameters may be used in the processes, examples of which include DCT block size and Qstep. In some embodiments, a block size of 4×4, 8×8, and/or 16×16 may be used by the frame analyzer 105 to estimate the bit cost for a macroblock(s) at one or more different block sizes. For example, and with reference to FIG. 3, the frame analyzer 105 may compute bit costs for macroblocks of the residual frame 200C. As depicted, a macroblock 302 within the residual frame 200C may be quantized using one or more quantization parameters. For example, the frame analyzer 105 may quantize a 4×4 DCT 304A of the macroblock 302. Additionally or alternatively, the frame analyzer 105 may quantize an 8×8 DCT 304B of the macroblock 302. The frame analyzer 105 may then dequantize the quantized data and compute respective bit costs using the dequantized data.

In one or more embodiments, the frame analyzer 105 may compute the bit cost for dequantized data D using Equation 1:

Cost=ΣLog₂(1+|D|) (1)

For example, at block 310A, the frame analyzer 105 may estimate the bit cost for the 4×4 DCT 304A of the macroblock 302 and at block 310B, the frame analyzer 105 may estimate the bit cost for the 8×8 DCT 304B of the macroblock 302. The frame analyzer 105 may then determine an estimate of entropy for the macroblock 302 at block 312 using the bit costs. For example and without limitation, the estimated entropy may comprise the maximum of the bit costs computed for the macroblock 302 using the different quantization parameters. While in the example of FIG. 3, multiple bit costs are computed for different configurations of quantization parameters, in other examples, any number of different quantization parameter configurations and/or corresponding bit costs being computed (e.g., one or more).

In one or more embodiments, the macroblock(s) identified by the frame analyzer 105 using the one or more filters and/or other analysis may be used by the frame analyzer 105 to generate a frame mask (e.g., a frame mask 210 of FIG. 2). The frame mask 210 includes masked regions or bits (e.g., masked bits 212) and unmasked regions or bits (e.g., unmasked bits 208). When applied to a frame, the masked bits 212 may indicate which macroblocks to exclude from the sub-frame 108A and the unmasked bits 208 may indicate which macroblocks to include in the sub-frame 108A.

In some embodiments, the masked regions may correspond to macroblocks that are filtered out by at least one macroblock filter. For example, the masked bits 212 may correspond to macroblocks that each have bit costs less than a threshold value. The unmasked regions may correspond to macroblocks that are not filtered out by a macroblock filter. For example, the unmasked bits 208 may correspond to macroblocks that each have bit costs greater than a threshold value.

Returning to the process 100 of FIG. 1, in embodiments where entropy of macroblocks is estimated and used to determine which macroblocks to include in the sub-frame 108A, the frame analyzer 105 may output the sub-frame 108A using the frame mask 210. For example, the frame analyzer 105 may apply the frame mask 210 to the residual frame 200C to identify the high entropy macroblock data from the residual frame 200C. The frame analyzer 105 may populate the sub-frame 108A such that the sub-frame 108A includes at least some of the identified high entropy macroblock data corresponding to unmasked regions of the frame mask 210. Further, the frame analyzer 105 may populate the sub-frame 108A such that the sub-frame 108A includes macroblock data from the motion-compensated frame. In one or more embodiments, the sub-frame 108A may comprise a sum of the motion-compensated frame and the masked residual frame 200C.

The process 100 includes the encoder 106A and the encoder 106B. Although depicted as independent encoders, it is contemplated that the encoders 106A and the encoder 106B may be the same encoder (e.g., different instances of the same encoder or the same instance of the same encoder), different encoders of an application server (e.g. the application server 702), and/or encoders of different application servers. In some embodiments, the encoders may be configured to encode frames or sub-frames as described in relation to the encoder 716 of FIG. 7. The encoders 106A and 106B may encode sub-frames using any algorithm or codec suitable to encode frame data. For example, the encoder 106A and the encoder 106B may output data encoded using an encoding/decoding specification, such as (for example and without limitation) H.264, H.265, VP9, and/or AV1, amongst others. The process 100 may include the encoder 106A receiving and encoding the sub-frame 108A to result in the encoded sub-frame 108B. For example, the encoded sub-frame 108B may comprise a P-frame or other type of frame encoding the sub-frame 108A using one or more reference frames, such as the previous frame 104.

The process 100 may also include the encoder 106B receiving the current frame 102 and encoding the current frame 102 to result in the encoded sub-frame 110. For example, the encoded sub-frame 110 may comprise a P-frame or other type of frame encoding the current frame 102 using one or more reference frames, such as the encoded sub-frame 108B.

In some embodiments, of the process 100, the encoded sub-frame 108B may be packetized into one or more packets 112 for transmission to a client device. Similarly, the encoded sub-frame 110 may be packetized into one or more packets 116. The packetizing of the sub-frames and/or transmission of the packets may be prioritized in some embodiments. For example, at least some of the encoded sub-frame 108B may be packetized and/or transmitted prior to and/or in advance of at least some of the encoded sub-frame 110 being generated by the encoder 106B.

Additionally, packet pacing may be applied to the transmission of one or more of the encoded sub-frames. For example, the transmission of packets of the encoded sub-frame 108B may be paced with an interval (e.g., Δt 114) between the packets of the encoded sub-frame 110, as shown. Additionally or alternatively, packet packing may be used for the packets within one or more of the encoded sub-frames. In at least one embodiment, one or more packets of the packet(s) 112 may be paced while the packet(s) 116 are not paced. Error correction may also be included in some embodiments. For example, forward error correction (FEC) may be included in the transmission of one or more packets (e.g., the packet(s) 112 and/or the packet(s) 116). In at least one embodiment, a communication interface (e.g., the communication interface 718 of FIG. 7) may facilitate the packetizing and transmitting of the one or more packets.

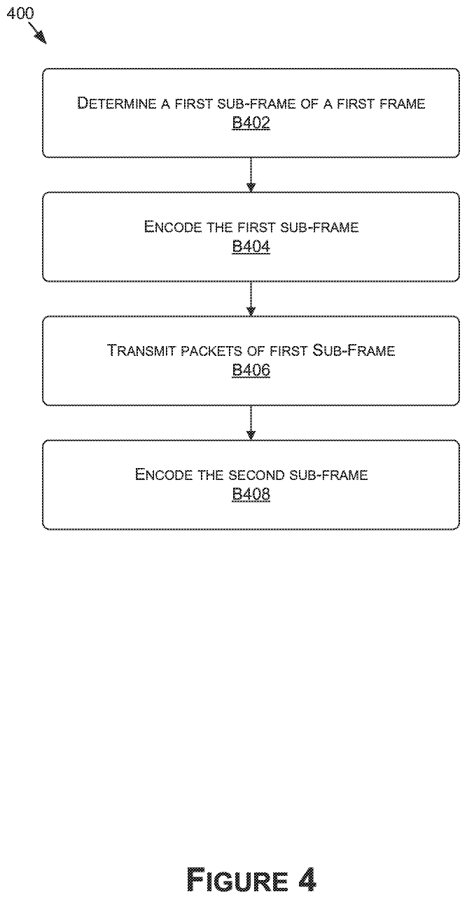

Now referring to FIG. 4, each block of method 400, described herein, comprises a computing process that may be performed using any combination of hardware, firmware, and/or software. For instance, various functions may be carried out by a processor executing instructions stored in memory. The method 400 may also be embodied as computer-usable instructions stored on computer storage media. The method 400 may be provided by a standalone application, a service or hosted service (standalone or in combination with another hosted service), or a plug-in to another product, to name a few. In addition, the method 400 is described, by way of example, with respect to the process 100 of FIG. 1. However, this method may additionally or alternatively be executed by any one system, or any combination of systems, including, but not limited to, those described herein.

FIG. 4 is a flow diagram showing the method 400 for encoding and transmitting video frames for streaming, in accordance with some embodiments of the present disclosure. The method 400, at block B402, includes determining a first sub-frame of a first frame. For example, the frame analyzer 105 may determine the sub-frame 108A based at least on the current frame 102 and the previous frame 104.

The method 400, at block B404, includes encoding the first sub-frame. For example, the encoder 106A may encode the sub-frame 108A of the current frame 102 based at least on changes between the previous frame 104 and the current frame 102 to generate the encoded sub-frame 108B.

The method 400, at block B406, includes transmitting packets representing the encoded first sub-frame. For example, one or more of the packets 112 may be transmitted to a client device.

The method 400, at block B408, includes generating an encoded second sub-frame. For example, the encoder 106B may generate the encoded sub-frame 110 corresponding to changes between the encoded sub-frame 108B and the current frame 102.

Referring now to FIGS. 5A and 5B, FIGS. 5A and 5B are block diagrams of example processes 500A and 500B for display of frames based on one or more sub-frames, in accordance with some embodiments of the present disclosure. The processes 500A and 500B may include a client device (e.g., the client device(s) 704 of FIG. 7) decoding one or more encoded sub-frames (e.g., the encoded sub-frame 108B and the encoded sub-frame 110 of FIG. 1) transmitted by a server (e.g., the application server(s) 702 of FIG. 7). In some embodiments, the encoded sub-frame(s) may be transmitted to the client device as described in relation to the process 100 of FIG. 1.

The processes 500A and 500B may be used to render and/or display a sequence of frames using encoded sub-frames. For example, the process 500A may include rendering and/or displaying a series of frames based on a corresponding series of sub-frames. As depicted, process 500A includes rendering a frame 502, followed by frame_{N-1} 504, followed by a frame_{N} 506, followed by a frame_{N+1} 506. The process 500A further shows sub-frames which may correspond to the frame_{N-1} 504 and the frame_{N} 506. For example, the process 500A depicts a series of inter-frame periods separated by a synchronization period (e.g., a sync 508 and a sync 510). During an inter-frame period, a decoder may decode one or more encoded sub-frames (e.g., the encoded sub-frame 108B of FIG. 1) to render and/or display a subsequent frame (e.g., the current frame 102), such as described in relation to the decoder 722 and the display 724 of FIG. 7. For example, the decoder may decode an encoded sub-frame A_{N} from the frame_{N-1} 504 to produce the sub-frame A_{N} 108A. Then the decoder may decode the sub-frame B_{N} 512 from the sub-frame A_{N} 108A to result in the frame_{N} 506. Other inter-frame periods may operate similar to the forgoing example. In each inter-frame period, the first sub-frame(s) (e.g., the sub-frame A_{N}) may be generated similar to the encoded sub-frame A 108B and may be referred to as a base sub-frame (or layer). Further, the second sub-frame(s) (e.g., the sub-frame B_{N}) may be generated similar to the encoded sub-frame B 110 and may be referred to as an enhancement sub-frame (or layer). In some embodiments, at a synchronization period the client device may provide the prepared frame data for display by a display device. For example, at the sync 510 the client device may display the frame_{N} 506, where frame_{N-1} 504 may have been previously displayed. Further, at or after the synchronization period, the client device may receive one or more packets of one or more encoded sub-frames for a subsequent frame.

The process 500B may operate similar to the process 500A. However, an event 514 disrupts the availability of the encoded sub-frame for use in generating the sub-frame B_{N}. In some embodiments, the event 514 may correspond to a delayed receipt of the encoded sub-frame. For example, network traffic may delay the receipt of the encoded sub-frame by a client device. In some embodiments, the event 514 may correspond to corruption of data representing the encoded sub-frame. For example, a packet that represents at least one macroblock of the encoded sub-frame may be lost or corrupted during transmission to the client device. In some embodiments, the event 514 may correspond to a determination to render and/or display a subsequent frame without using the encoded sub-frame. For example, the client device may determine to render and/or display a subsequent frame without using the encoded sub-frame based at least on analyzing computing resources available for the decoding. In some embodiments, the event 514 may correspond to a determination not to send the encoded sub-frame to the client device. For example, the server may determine not to send one or more portions of the encoded sub-frame based at least on network bandwidth associated with the server and/or based at least on an indication from the client device (e.g., a request not to send one or more encoded sub-frames).

In situations where the event 514 occurs, rather than displaying the frame_{N} 506 corresponding to the sub-frame B_{N}, the client device may display the frame_{N} 516 corresponding to the sub-frame A_{N}. Additionally or alternatively, rather than decoding an encoded sub-frame A_{N+1} from the frame_{N} 506 to produce the sub-frame A_{N+1} (e.g., as depicted in FIG. 5A), the sub-frame A_{N+1} is decoded from the frame_{N} 516 to produce the sub-frame A_{N+1}. Because the sub-frame A_{N} 108A may include critical information for the current frame, such as all or most of motion-compensated information and/or high entropy data, the frame_{N} 516 may be used for these purposes without significant disruption to rendering and/or displaying the sequence of frames.

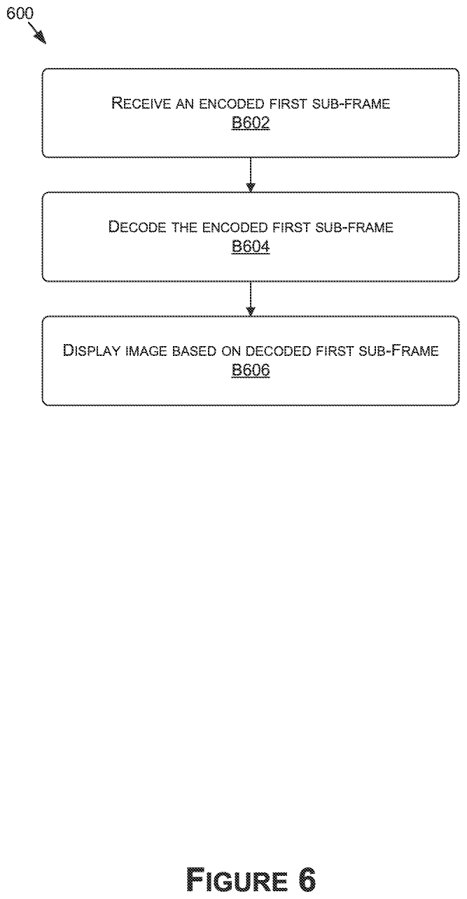

Now referring to FIG. 6, each block of method 600, described herein, comprises a computing process that may be performed using any combination of hardware, firmware, and/or software. For instance, various functions may be carried out by a processor executing instructions stored in memory. The method 600 may also be embodied as computer-usable instructions stored on computer storage media. The method 600 may be provided by a standalone application, a service or hosted service (standalone or in combination with another hosted service), or a plug-in to another product, to name a few. In addition, method 600 is described, by way of example, with respect to the process 500A of FIG. 5A or the process 500B of FIG. 5B with the process 100 of FIG. 1. However, this method may additionally or alternatively be executed by any one system, or any combination of systems, including, but not limited to, those described herein.

FIG. 6 is a block diagram of the method 600 for decoding and displaying a frame based on one or more sub-frames, in accordance with some embodiments of the present disclosure. The method 600, at block B602, includes receiving an encoded first a first sub-frame of a first frame. For example, for example, a client device may receive, in a video stream, one or more packets representing an encoded version of the sub-frame 108A of a plurality of sub-frames of the current frame 102 of a sequence of frames. The encoded version of the sub-frame 108A may correspond to the encoded sub-frame 108B capturing changes between the previous frame 104 and the sub-frame 108A.

The method 600, at block B604, includes decoding the encoded first sub-frame. For example, a decoder (e.g., decoder 722 of FIG. 7) may decode the encoded version of the sub-frame 108A based at least on applying the encoded version of the sub-frame 108A to the frame_{N-1} previously decoded from the video stream to generate a decoded version of the current frame 102. Where an encoded version of the sub-frame B is employed, the decoded version may correspond to the frame_{N} 506. Otherwise, the decoded version may correspond to the frame_{N} 516.

The method 600, at block B606, includes displaying an image based on the decoded first sub-frame. For example, the frame_{N} 506, the frame_{N} 516, and/or image data generated therefrom may be displayed using the client device.

The systems and methods described herein may be used for a variety of purposes, by way of example and without limitation, for synthetic data generation, model training, perception, augmented reality, virtual reality, mixed reality, robotics, security and surveillance, autonomous or semi-autonomous machine applications, deep learning, environment simulation, data center processing, conversational AI, light transport simulation (e.g., ray-tracing, path tracing, etc.), collaborative content creation for 3D assets, cloud computing and/or any other suitable applications.

Disclosed embodiments may be comprised in a variety of different systems such as automotive systems (e.g., a control system for an autonomous or semi-autonomous machine, a perception system for an autonomous or semi-autonomous machine), systems implemented using a robot, aerial systems, medial systems, boating systems, smart area monitoring systems, systems for performing deep learning operations, systems for performing simulation operations, systems implemented using an edge device, systems incorporating one or more virtual machines (VMs), systems for performing synthetic data generation operations, systems implemented at least partially in a data center, systems for performing conversational AI operations, systems for performing light transport simulation, systems for performing collaborative content creation for 3D assets, systems implemented at least partially using cloud computing resources, and/or other types of systems.

Example Content Streaming System

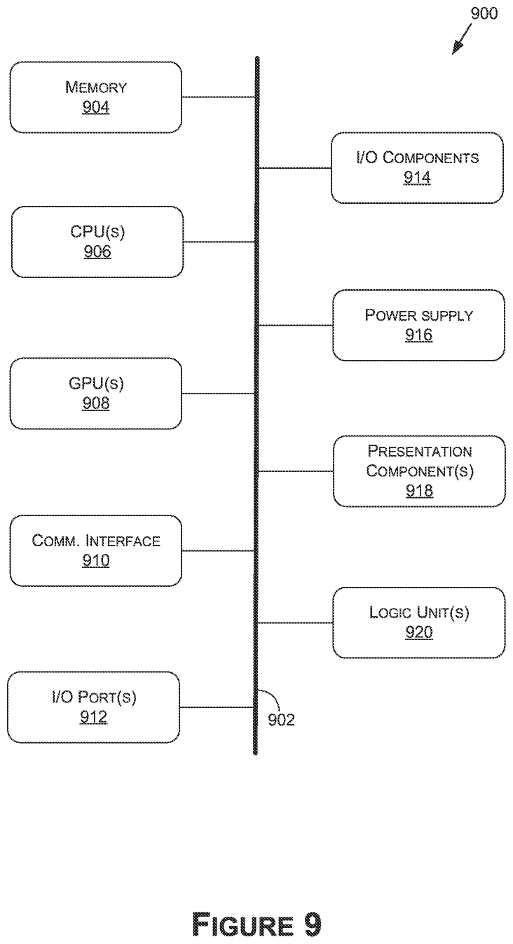

Now referring to FIG. 7, FIG. 7 is an example system diagram for a content streaming system 700, in accordance with some embodiments of the present disclosure. FIG. 7 includes application server(s) 702 (which may include similar components, features, and/or functionality to the example computing device 900 of FIG. 9), client device(s) 704 (which may include similar components, features, and/or functionality to the example computing device 900 of FIG. 9), and network(s) 706 (which may be similar to the network(s) described herein). In some embodiments of the present disclosure, the system 700 may be implemented. The application session may correspond to a game streaming application (e.g., NVIDIA GeFORCE NOW), a remote desktop application, a simulation application (e.g., autonomous or semi-autonomous vehicle simulation), computer aided design (CAD) applications, a platform for collaborative 3D content creation applications, virtual reality (VR) and/or augmented reality (AR) streaming applications, deep learning applications, and/or other application types.

In the system 700, for an application session, the client device(s) 704 may only receive input data in response to inputs to the input device(s), transmit the input data to the application server(s) 702, receive encoded display data from the application server(s) 702, and display the display data on the display 724. As such, the more computationally intense computing and processing is offloaded to the application server(s) 702 (e.g., rendering—in particular light transport simulation techniques such as ray or path tracing—for graphical output of the application session is executed by the GPU(s) of the game server(s) 702). In other words, the application session is streamed to the client device(s) 704 from the application server(s) 702, thereby reducing the requirements of the client device(s) 704 for graphics processing and rendering.

For example, with respect to an instantiation of an application session, a client device 704 may be displaying a frame of the application session on the display 724 based on receiving the display data from the application server(s) 702. The client device 704 may receive an input to one of the input device(s) and generate input data in response. The client device 704 may transmit the input data to the application server(s) 702 via the communication interface 720 and over the network(s) 706 (e.g., the Internet), and the application server(s) 702 may receive the input data via the communication interface 718. The CPU(s) 708 may receive the input data, process the input data, and transmit data to the GPU(s) 710 that causes the GPU(s) 710 to generate a rendering of the application session. For example, the input data may be representative of a movement of a character of the user in a game session of a game application, firing a weapon, reloading, passing a ball, turning a vehicle, etc. The rendering component 712 may render the application session (e.g., representative of the result of the input data) and the rendering capture component 714 may capture the rendering of the application session as display data (e.g., as image data capturing the rendered frame of the application session). The rendering of the application session may include ray or path-traced lighting and/or shadow effects, computed using one or more parallel processing units—such as GPUs, which may further employ the use of one or more dedicated hardware accelerators or processing cores to perform ray or path-tracing techniques—of the application server(s) 702. In some embodiments, one or more virtual machines (VMs)— e.g., including one or more virtual components, such as vGPUs, vCPUs, etc. —may be used by the application server(s) 702 to support the application sessions. The encoder 716 may then encode the display data to generate encoded display data and the encoded display data may be transmitted to the client device 704 over the network(s) 706 via the communication interface 718. The client device 704 may receive the encoded display data via the communication interface 720 and the decoder 722 may decode the encoded display data to generate the display data. The client device 704 may then display the display data via the display 724.

Example Data Center

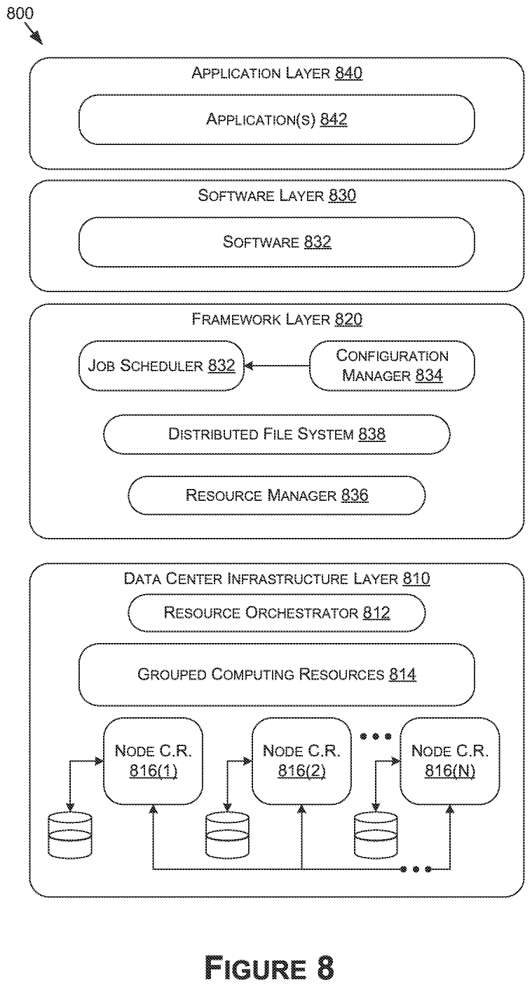

FIG. 8 illustrates an example data center 800 that may be used in at least one embodiments of the present disclosure. The data center 800 may include a data center infrastructure layer 810, a framework layer 820, a software layer 830, and/or an application layer 840.

As shown in FIG. 8, the data center infrastructure layer 810 may include a resource orchestrator 812, grouped computing resources 814, and node computing resources (“node C.R.s”) 816(1)-816(N), where “N” represents any whole, positive integer. In at least one embodiment, node C.R.s 816(1)-816(N) may include, but are not limited to, any number of central processing units (CPUs) or other processors (including DPUs, accelerators, field programmable gate arrays (FPGAs), graphics processors or graphics processing units (GPUs), etc.), memory devices (e.g., dynamic read-only memory), storage devices (e.g., solid state or disk drives), network input/output (NW I/O) devices, network switches, virtual machines (VMs), power modules, and/or cooling modules, etc. In some embodiments, one or more node C.R.s from among node C.R.s 816(1)-816(N) may correspond to a server having one or more of the above-mentioned computing resources. In addition, in some embodiments, the node C.R.s 816(1)-8161(N) may include one or more virtual components, such as vGPUs, vCPUs, and/or the like, and/or one or more of the node C.R.s 816(1)-816(N) may correspond to a virtual machine (VM).

In at least one embodiment, grouped computing resources 814 may include separate groupings of node C.R.s 816 housed within one or more racks (not shown), or many racks housed in data centers at various geographical locations (also not shown). Separate groupings of node C.R.s 816 within grouped computing resources 814 may include grouped compute, network, memory or storage resources that may be configured or allocated to support one or more workloads. In at least one embodiment, several node C.R.s 816 including CPUs, GPUs, DPUs, and/or other processors may be grouped within one or more racks to provide compute resources to support one or more workloads. The one or more racks may also include any number of power modules, cooling modules, and/or network switches, in any combination.

The resource orchestrator 812 may configure or otherwise control one or more node C.R.s 816(1)-816(N) and/or grouped computing resources 814. In at least one embodiment, resource orchestrator 812 may include a software design infrastructure (SDI) management entity for the data center 800. The resource orchestrator 812 may include hardware, software, or some combination thereof.

In at least one embodiment, as shown in FIG. 8, framework layer 820 may include a job scheduler 832, a configuration manager 834, a resource manager 836, and/or a distributed file system 838. The framework layer 820 may include a framework to support software 833 of software layer 830 and/or one or more application(s) 842 of application layer 840. The software 833 or application(s) 842 may respectively include web-based service software or applications, such as those provided by Amazon Web Services, Google Cloud and Microsoft Azure. The framework layer 820 may be, but is not limited to, a type of free and open-source software web application framework such as Apache Spark™ (hereinafter “Spark”) that may utilize distributed file system 838 for large-scale data processing (e.g., “big data”). In at least one embodiment, job scheduler 832 may include a Spark driver to facilitate scheduling of workloads supported by various layers of data center 800. The configuration manager 834 may be capable of configuring different layers such as software layer 830 and framework layer 820 including Spark and distributed file system 838 for supporting large-scale data processing. The resource manager 836 may be capable of managing clustered or grouped computing resources mapped to or allocated for support of distributed file system 838 and job scheduler 832. In at least one embodiment, clustered or grouped computing resources may include grouped computing resource 814 at data center infrastructure layer 810. The resource manager 836 may coordinate with resource orchestrator 812 to manage these mapped or allocated computing resources.

In at least one embodiment, software 833 included in software layer 830 may include software used by at least portions of node C.R.s 816(1)-816(N), grouped computing resources 814, and/or distributed file system 838 of framework layer 820. One or more types of software may include, but are not limited to, Internet web page search software, e-mail virus scan software, database software, and streaming video content software.

In at least one embodiment, application(s) 842 included in application layer 840 may include one or more types of applications used by at least portions of node C.R.s 816(1)-816(N), grouped computing resources 814, and/or distributed file system 838 of framework layer 820. One or more types of applications may include, but are not limited to, any number of a genomics application, a cognitive compute, and a machine learning application, including training or inferencing software, machine learning framework software (e.g., PyTorch, TensorFlow, Caffe, etc.), and/or other machine learning applications used in conjunction with one or more embodiments.

In at least one embodiment, any of configuration manager 834, resource manager 836, and resource orchestrator 812 may implement any number and type of self-modifying actions based on any amount and type of data acquired in any technically feasible fashion. Self-modifying actions may relieve a data center operator of data center 800 from making possibly bad configuration decisions and possibly avoiding underutilized and/or poor performing portions of a data center.

The data center 800 may include tools, services, software or other resources to train one or more machine learning models or predict or infer information using one or more machine learning models according to one or more embodiments described herein. For example, a machine learning model(s) may be trained by calculating weight parameters according to a neural network architecture using software and/or computing resources described above with respect to the data center 800. In at least one embodiment, trained or deployed machine learning models corresponding to one or more neural networks may be used to infer or predict information using resources described above with respect to the data center 800 by using weight parameters calculated through one or more training techniques, such as but not limited to those described herein.

In at least one embodiment, the data center 800 may use CPUs, application-specific integrated circuits (ASICs), GPUs, FPGAs, and/or other hardware (or virtual compute resources corresponding thereto) to perform training and/or inferencing using above-described resources. Moreover, one or more software and/or hardware resources described above may be configured as a service to allow users to train or performing inferencing of information, such as image recognition, speech recognition, or other artificial intelligence services.

Example Computing Device

FIG. 9 is a block diagram of an example computing device(s) 900 suitable for use in implementing some embodiments of the present disclosure. Computing device 900 may include an interconnect system 902 that directly or indirectly couples the following devices: memory 904, one or more central processing units (CPUs) 906, one or more graphics processing units (GPUs) 908, a communication interface 910, input/output (I/O) ports 912, input/output components 914, a power supply 916, one or more presentation components 918 (e.g., display(s)), and one or more logic units 920. In at least one embodiment, the computing device(s) 900 may comprise one or more virtual machines (VMs), and/or any of the components thereof may comprise virtual components (e.g., virtual hardware components). For non-limiting examples, one or more of the GPUs 908 may comprise one or more vGPUs, one or more of the CPUs 906 may comprise one or more vCPUs, and/or one or more of the logic units 920 may comprise one or more virtual logic units. As such, a computing device(s) 900 may include discrete components (e.g., a full GPU dedicated to the computing device 900), virtual components (e.g., a portion of a GPU dedicated to the computing device 900), or a combination thereof.

Although the various blocks of FIG. 9 are shown as connected via the interconnect system 902 with lines, this is not intended to be limiting and is for clarity only. For example, in some embodiments, a presentation component 918, such as a display device, may be considered an I/O component 914 (e.g., if the display is a touch screen). As another example, the CPUs 906 and/or GPUs 908 may include memory (e.g., the memory 904 may be representative of a storage device in addition to the memory of the GPUs 908, the CPUs 906, and/or other components). In other words, the computing device of FIG. 9 is merely illustrative. Distinction is not made between such categories as “workstation,” “server,” “laptop,” “desktop,” “tablet,” “client device,” “mobile device,” “hand-held device,” “game console,” “electronic control unit (ECU),” “virtual reality system,” and/or other device or system types, as all are contemplated within the scope of the computing device of FIG. 9.

The interconnect system 902 may represent one or more links or busses, such as an address bus, a data bus, a control bus, or a combination thereof. The interconnect system 902 may include one or more bus or link types, such as an industry standard architecture (ISA) bus, an extended industry standard architecture (EISA) bus, a video electronics standards association (VESA) bus, a peripheral component interconnect (PCI) bus, a peripheral component interconnect express (PCIe) bus, and/or another type of bus or link. In some embodiments, there are direct connections between components. As an example, the CPU 906 may be directly connected to the memory 904. Further, the CPU 906 may be directly connected to the GPU 908. Where there is direct, or point-to-point connection between components, the interconnect system 902 may include a PCIe link to carry out the connection. In these examples, a PCI bus need not be included in the computing device 900.

The memory 904 may include any of a variety of computer-readable media. The computer-readable media may be any available media that may be accessed by the computing device 900. The computer-readable media may include both volatile and nonvolatile media, and removable and non-removable media. By way of example, and not limitation, the computer-readable media may comprise computer-storage media and communication media.

The computer-storage media may include both volatile and nonvolatile media and/or removable and non-removable media implemented in any method or technology for storage of information such as computer-readable instructions, data structures, program modules, and/or other data types. For example, the memory 904 may store computer-readable instructions (e.g., that represent a program(s) and/or a program element(s), such as an operating system. Computer-storage media may include, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which may be used to store the desired information and which may be accessed by computing device 900. As used herein, computer storage media does not comprise signals per se.

The computer storage media may embody computer-readable instructions, data structures, program modules, and/or other data types in a modulated data signal such as a carrier wave or other transport mechanism and includes any information delivery media. The term “modulated data signal” may refer to a signal that has one or more of its characteristics set or changed in such a manner as to encode information in the signal. By way of example, and not limitation, the computer storage media may include wired media such as a wired network or direct-wired connection, and wireless media such as acoustic, RF, infrared and other wireless media. Combinations of any of the above should also be included within the scope of computer-readable media.

The CPU(s) 906 may be configured to execute at least some of the computer-readable instructions to control one or more components of the computing device 900 to perform one or more of the methods and/or processes described herein. The CPU(s) 906 may each include one or more cores (e.g., one, two, four, eight, twenty-eight, seventy-two, etc.) that are capable of handling a multitude of software threads simultaneously. The CPU(s) 906 may include any type of processor, and may include different types of processors depending on the type of computing device 900 implemented (e.g., processors with fewer cores for mobile devices and processors with more cores for servers). For example, depending on the type of computing device 900, the processor may be an Advanced RISC Machines (ARM) processor implemented using Reduced Instruction Set Computing (RISC) or an x86 processor implemented using Complex Instruction Set Computing (CISC). The computing device 900 may include one or more CPUs 906 in addition to one or more microprocessors or supplementary co-processors, such as math co-processors.

In addition to or alternatively from the CPU(s) 906, the GPU(s) 908 may be configured to execute at least some of the computer-readable instructions to control one or more components of the computing device 900 to perform one or more of the methods and/or processes described herein. One or more of the GPU(s) 908 may be an integrated GPU (e.g., with one or more of the CPU(s) 906 and/or one or more of the GPU(s) 908 may be a discrete GPU. In embodiments, one or more of the GPU(s) 908 may be a coprocessor of one or more of the CPU(s) 906. The GPU(s) 908 may be used by the computing device 900 to render graphics (e.g., 3D graphics) or perform general purpose computations. For example, the GPU(s) 908 may be used for General-Purpose computing on GPUs (GPGPU). The GPU(s) 908 may include hundreds or thousands of cores that are capable of handling hundreds or thousands of software threads simultaneously. The GPU(s) 908 may generate pixel data for output images in response to rendering commands (e.g., rendering commands from the CPU(s) 906 received via a host interface). The GPU(s) 908 may include graphics memory, such as display memory, for storing pixel data or any other suitable data, such as GPGPU data. The display memory may be included as part of the memory 904. The GPU(s) 908 may include two or more GPUs operating in parallel (e.g., via a link). The link may directly connect the GPUs (e.g., using NVLINK) or may connect the GPUs through a switch (e.g., using NVSwitch). When combined together, each GPU 908 may generate pixel data or GPGPU data for different portions of an output or for different outputs (e.g., a first GPU for a first image and a second GPU for a second image). Each GPU may include its own memory, or may share memory with other GPUs.

In addition to or alternatively from the CPU(s) 906 and/or the GPU(s) 908, the logic unit(s) 920 may be configured to execute at least some of the computer-readable instructions to control one or more components of the computing device 900 to perform one or more of the methods and/or processes described herein. In embodiments, the CPU(s) 906, the GPU(s) 908, and/or the logic unit(s) 920 may discretely or jointly perform any combination of the methods, processes and/or portions thereof. One or more of the logic units 920 may be part of and/or integrated in one or more of the CPU(s) 906 and/or the GPU(s) 908 and/or one or more of the logic units 920 may be discrete components or otherwise external to the CPU(s) 906 and/or the GPU(s) 908. In embodiments, one or more of the logic units 920 may be a coprocessor of one or more of the CPU(s) 906 and/or one or more of the GPU(s) 908.

Examples of the logic unit(s) 920 include one or more processing cores and/or components thereof, such as Data Processing Units (DPUs), Tensor Cores (TCs), Tensor Processing Units (TPUs), Pixel Visual Cores (PVCs), Vision Processing Units (VPUs), Graphics Processing Clusters (GPCs), Texture Processing Clusters (TPCs), Streaming Multiprocessors (SMs), Tree Traversal Units (TTUs), Artificial Intelligence Accelerators (AIAs), Deep Learning Accelerators (DLAs), Arithmetic-Logic Units (ALUs), Application-Specific Integrated Circuits (ASICs), Floating Point Units (FPUs), input/output (I/O) elements, peripheral component interconnect (PCI) or peripheral component interconnect express (PCIe) elements, and/or the like.

The communication interface 910 may include one or more receivers, transmitters, and/or transceivers that enable the computing device 900 to communicate with other computing devices via an electronic communication network, included wired and/or wireless communications. The communication interface 910 may include components and functionality to enable communication over any of a number of different networks, such as wireless networks (e.g., Wi-Fi, Z-Wave, Bluetooth, Bluetooth LE, ZigBee, etc.), wired networks (e.g., communicating over Ethernet or InfiniBand), low-power wide-area networks (e.g., LoRaWAN, SigFox, etc.), and/or the Internet. In one or more embodiments, logic unit(s) 920 and/or communication interface 910 may include one or more data processing units (DPUs) to transmit data received over a network and/or through interconnect system 902 directly to (e.g., a memory of) one or more GPU(s) 908.

The I/O ports 912 may enable the computing device 900 to be logically coupled to other devices including the I/O components 914, the presentation component(s) 918, and/or other components, some of which may be built in to (e.g., integrated in) the computing device 900. Illustrative I/O components 914 include a microphone, mouse, keyboard, joystick, game pad, game controller, satellite dish, scanner, printer, wireless device, etc. The I/O components 914 may provide a natural user interface (NUI) that processes air gestures, voice, or other physiological inputs generated by a user. In some instances, inputs may be transmitted to an appropriate network element for further processing. An NUI may implement any combination of speech recognition, stylus recognition, facial recognition, biometric recognition, gesture recognition both on screen and adjacent to the screen, air gestures, head and eye tracking, and touch recognition (as described in more detail below) associated with a display of the computing device 900. The computing device 900 may be include depth cameras, such as stereoscopic camera systems, infrared camera systems, RGB camera systems, touchscreen technology, and combinations of these, for gesture detection and recognition. Additionally, the computing device 900 may include accelerometers or gyroscopes (e.g., as part of an inertia measurement unit (IMU)) that enable detection of motion. In some examples, the output of the accelerometers or gyroscopes may be used by the computing device 900 to render immersive augmented reality or virtual reality.

The power supply 916 may include a hard-wired power supply, a battery power supply, or a combination thereof. The power supply 916 may provide power to the computing device 900 to enable the components of the computing device 900 to operate.

The presentation component(s) 918 may include a display (e.g., a monitor, a touch screen, a television screen, a heads-up-display (HUD), other display types, or a combination thereof), speakers, and/or other presentation components. The presentation component(s) 918 may receive data from other components (e.g., the GPU(s) 908, the CPU(s) 906, DPUs, etc.), and output the data (e.g., as an image, video, sound, etc.).

Example Network Environments

Network environments suitable for use in implementing embodiments of the disclosure may include one or more client devices, servers, network attached storage (NAS), other backend devices, and/or other device types. The client devices, servers, and/or other device types (e.g., each device) may be implemented on one or more instances of the computing device(s) 900 of FIG. 9—e.g., each device may include similar components, features, and/or functionality of the computing device(s) 900. In addition, where backend devices (e.g., servers, NAS, etc.) are implemented, the backend devices may be included as part of a data center 800, an example of which is described in more detail herein with respect to FIG. 8.

Components of a network environment may communicate with each other via a network(s), which may be wired, wireless, or both. The network may include multiple networks, or a network of networks. By way of example, the network may include one or more Wide Area Networks (WANs), one or more Local Area Networks (LANs), one or more public networks such as the Internet and/or a public switched telephone network (PSTN), and/or one or more private networks. Where the network includes a wireless telecommunications network, components such as a base station, a communications tower, or even access points (as well as other components) may provide wireless connectivity.

Compatible network environments may include one or more peer-to-peer network environments—in which case a server may not be included in a network environment—and one or more client-server network environments—in which case one or more servers may be included in a network environment. In peer-to-peer network environments, functionality described herein with respect to a server(s) may be implemented on any number of client devices.

In at least one embodiment, a network environment may include one or more cloud-based network environments, a distributed computing environment, a combination thereof, etc. A cloud-based network environment may include a framework layer, a job scheduler, a resource manager, and a distributed file system implemented on one or more of servers, which may include one or more core network servers and/or edge servers. A framework layer may include a framework to support software of a software layer and/or one or more application(s) of an application layer. The software or application(s) may respectively include web-based service software or applications. In embodiments, one or more of the client devices may use the web-based service software or applications (e.g., by accessing the service software and/or applications via one or more application programming interfaces (APIs)). The framework layer may be, but is not limited to, a type of free and open-source software web application framework such as that may use a distributed file system for large-scale data processing (e.g., “big data”).

A cloud-based network environment may provide cloud computing and/or cloud storage that carries out any combination of computing and/or data storage functions described herein (or one or more portions thereof). Any of these various functions may be distributed over multiple locations from central or core servers (e.g., of one or more data centers that may be distributed across a state, a region, a country, the globe, etc.). If a connection to a user (e.g., a client device) is relatively close to an edge server(s), a core server(s) may designate at least a portion of the functionality to the edge server(s). A cloud-based network environment may be private (e.g., limited to a single organization), may be public (e.g., available to many organizations), and/or a combination thereof (e.g., a hybrid cloud environment).

The client device(s) may include at least some of the components, features, and functionality of the example computing device(s) 900 described herein with respect to FIG. 9. By way of example and not limitation, a client device may be embodied as a Personal Computer (PC), a laptop computer, a mobile device, a smartphone, a tablet computer, a smart watch, a wearable computer, a Personal Digital Assistant (PDA), an MP3 player, a virtual reality headset, a Global Positioning System (GPS) or device, a video player, a video camera, a surveillance device or system, a vehicle, a boat, a flying vessel, a virtual machine, a drone, a robot, a handheld communications device, a hospital device, a gaming device or system, an entertainment system, a vehicle computer system, an embedded system controller, a remote control, an appliance, a consumer electronic device, a workstation, an edge device, any combination of these delineated devices, or any other suitable device.

The disclosure may be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to code that perform particular tasks or implement particular abstract data types. The disclosure may be practiced in a variety of system configurations, including hand-held devices, consumer electronics, general-purpose computers, more specialty computing devices, etc. The disclosure may also be practiced in distributed computing environments where tasks are performed by remote-processing devices that are linked through a communications network.

As used herein, a recitation of “and/or” with respect to two or more elements should be interpreted to mean only one element, or a combination of elements. For example, “element A, element B, and/or element C” may include only element A, only element B, only element C, element A and element B, element A and element C, element B and element C, or elements A, B, and C. In addition, “at least one of element A or element B” may include at least one of element A, at least one of element B, or at least one of element A and at least one of element B. Further, “at least one of element A and element B” may include at least one of element A, at least one of element B, or at least one of element A and at least one of element B.

The subject matter of the present disclosure is described with specificity herein to meet statutory requirements. However, the description itself is not intended to limit the scope of this disclosure. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

What is claimed is:

1. A method comprising:
determining, for a first frame of a sequence of frames, a sub-frame of the first frame based at least on motion-compensating the first frame using a second frame prior to the first frame in the sequence of frames;
encoding the sub-frame of the first frame based at least on one or more changes between the second frame and the sub-frame to generate a first encoded sub-frame of the first frame;
transmitting a first set of one or more packets to one or more client devices, the first set representing the first encoded sub-frame;
generating a second encoded sub-frame of the first frame corresponding to one or more changes between the first encoded sub-frame and the first frame; and
transmitting a second set of one or more packets to the one or more client devices, the second set representing the second encoded sub-frame.

2. The method of claim 1, wherein the determining of the sub-frame includes:
determining a cost of encoding one or more macroblocks corresponding to the first frame exceeds a threshold value; and
including data corresponding to the one or more macroblocks in the sub-frame based at least on the cost exceeding the threshold value.

3. The method of claim 3, wherein the threshold value is computed based at least on a mean cost of encoding a plurality of macroblocks corresponding to the first frame.

4. The method of claim 1, further comprising:
estimating entropy of one or more macroblocks corresponding to the first frame based at least on de-quantizing the one or more macroblocks using one or more block sizes; and
including data corresponding to the one or more macroblocks in the sub-frame based at least on the entropy

5. The method of claim 1, wherein the first encoded sub-frame is transmitted to the one or more client devices using more error correction data than the second encoded sub-frame.

6. The method of claim 1, wherein the first encoded sub-frame is transmitted when the first sub-frame is encoded, and before the second encoded sub-frame is transmitted.

7. The method of claim 1, wherein the determining of the sub-frame includes:
performing the motion-compensating to generate motion-compensated data associated with the first frame;
computing a residual associated with the first frame using the motion-compensated data; and
applying the mask to the residual to combine the motion-compensated data with a subset of the residual.

8. The method of claim 1, wherein at least one of the first one or more packets are transmitted during the generating of the second encoded sub-frame.

9. A system comprising:
one or more processing units; and
one or more memory units storing instructions that, when executed by the one or more processing units, cause the one or more processing units to execute operations comprising:
receiving, in a video stream, one or more packets representing an encoded sub-frame of a first frame of a sequence of frames, the encoded sub-frame capturing one or more changes between a second frame of the sequence of frames and a sub-frame of the frame;
decoding the encoded sub-frame based at least on applying the encoded sub-frame to a previously decoded frame from the video stream to generate a decoded version of the first frame, and
displaying one or more images corresponding to the decoded version of the first frame.

10. The system of claim 9, wherein the encoded sub-frame is a first encoded sub-frame and the operations further comprises:
receiving, in the video stream, data representing a second encoded sub-frame of the first frame; and
decoding the second encoded sub-frame based at least on applying the second encoded sub-frame to the decoded version of the first frame to generate an additional decoded version of the first frame, wherein the one or more images include an image represented by the additional decoded version of the first frame.

11. The system of claim 9, wherein the encoded sub-frame is a first encoded sub-frame and the one or more images include an image represented by the decoded version of the first frame based at least on data representing at least a portion of a second encoded sub-frame of the first frame being dropped from the video stream.

12. The system of claim 9, wherein the sub-frame corresponds at least in part to a motion-compensated version of the first frame.

13. The system of claim 9, wherein the encoded sub-frame is a first encoded sub-frame and the operations further comprise receiving, in the video stream, data representing at least a portion of a second encoded sub-frame of the first frame, wherein the second encoded sub-frame corresponds at least in part to a residual of the sub-frame.

14. The system of claim 9, wherein a pacing delay is included between the one or more packets representing the encoded sub-frame of the first frame and one or more packets representing a another encoded sub-frame of the first frame.

15. The system of claim 9, wherein the system is comprised in at least one of:
a control system for an autonomous or semi-autonomous machine;
a perception system for an autonomous or semi-autonomous machine;
a system for performing synthetic data generation operations;
a system for performing conversational AI operations;
a system for performing simulation operations;
a system for performing deep learning operations;
a system implemented using an edge device;
a system implemented using a robot;
a system incorporating one or more virtual machines (VMs);
a system implemented at least partially in a data center;
a system including a collaborative creation platform for three-dimensional (3D) content; or
a system implemented at least partially using cloud computing resources.

16. A processor comprising:
one or more circuits to generate, from a first frame in a sequence of frames, one or more encoded sub-frames of the first frame based at least on motion information between the first frame and a second frame in the sequence of frames, and transmit one or more packets representing the one or more encoded sub-frames to one or more client devices.

17. The processor of claim 16, wherein the one or more packets include first one or more packets representing a first encoded sub-frame of the one or more encoded sub-frames and second one or more packets representing a second encoded sub-frame of the one or more encoded sub-frames.

18. The processor of claim 16, wherein the one or more circuits are to:
determine a cost of encoding one or more macroblocks corresponding to the first frame exceeds a threshold value; and
include data corresponding to the one or more macroblocks in a first encoded sub-frame of the one or more encoded sub-frames based at least on the cost exceeding the threshold value.

19. The processor of claim 18, wherein the threshold value is computed based at least on a mean cost of encoding a plurality of macroblocks corresponding to the first frame.

20. The processor of claim 16, wherein the processor is comprised in at least one of:
a control system for an autonomous or semi-autonomous machine;
a perception system for an autonomous or semi-autonomous machine;
a system for performing simulation operations;
a system for performing deep learning operations;
a system for performing synthetic data generation operations;
a system for performing conversational AI operations;
a system implemented using an edge device;
a system implemented using a robot;
a system incorporating one or more virtual machines (VMs);
a system implemented at least partially in a data center;
a system including a collaborative creation platform for three-dimensional (3D) content; or
a system implemented at least partially using cloud computing resources.
